(19) United States
(12) Patent Application Publication
(10) Pub. No.: US 2002/0063033 A1
(43) Pub. Date: May 30, 2002

(54) System and method for exchanging of at least one item

(76) Inventors: Gad Ben-Naim, Ashdod (IL); Israel Tenenboim, Tel Aviv (IL)

Correspondence Address: DR. MARK FRIEDMAN LTD, C/O BILL POLKINGHORN-DISCOVERY DISPATCH, 9003 FLORIN WAY, UPPER MARLBORO, MD, 20772, US

(21) Appl. No.: 09/726,048

(22) Filed: Nov. 30, 2000

(51) Int. Cl. G07F 7/00

(52) U.S. Cl. 194/214

(57) ABSTRACT

The present invention relates to a system and method for exchanging of at least one item belonging to a plurality of comparable items. More specifically the invention relates to a system and method for exchanging fabric items such as institutional laundry, wherein the fabric items are received, identified, counted and immediately replaced.

### FIELD AND BACKGROUND OF THE INVENTION

The present invention relates to a system and method for exchanging of at least one item belonging to a plurality of comparable items. More specifically the invention relates to a system and method for exchanging fabric items such as institutional laundry, wherein the fabric items are received, identified, counted and immediately replaced.

U.S. Pat. No. 5,829,349 to Fitzgerald et al, describes an apparatus for receiving and compacting garments that can identify a particular user and collect the scrub garments from that user in a manner that permits subsequent identification of that user for issuance of clean scrub garments, preferably by a separate apparatus.

U.S. Pat. No. 6,050,421 to Hansen, describes an automatic laundry sorting system wherein previously laundered laundry items on hangers are tagged with electronic identification devices and sorted into predetermined groups such as garments belonging to an individual employee.

U.S. Pat. No. 5,072,822 to Smith, describes a computer controlled sorting system in which uniquely coded garments hung on trolleys, also having unique identification bar codes, carries a garment throughout the various routes of a garment sorting system.

U.S. Pat. No. 5,673,798 to Santicchi, describes a unique procedure for efficiently reading chips sown on garments.

U.S. Pat. No. 5,238,122 to Hart describes yet another method and apparatus for sorting garments of different sorts and types.

All of these prior art inventions deal with systems and apparatuses that facilitate receipt and identification of various textile articles as well as those which deal in their sub sequential return of clothing from various laundries and dry cleaners. These systems identify by various methods including bar code and radio frequency sensors. In these systems the specific articles of clothing is eventually to its owner after processing (e.g. laundering) based upon identification means which indicate ownership of a specific article of clothing by a specific person. Therefore these prior art patents are ill suited for use in other systems where employees exchange their clothing (for example scrubs), for a comparable item which does not necessarily belong to them. Such systems are common, for example, in hospitals, factories, military bases and educational institutes. Existing systems rely either upon an employee dedicated to this purpose or on an honor system whereby the user takes a comparable item for themselves. Assignment of an employee to perform this task is costly, while honor systems often lead to inventory shrinkage which is difficult to monitor and control.

There is therefore a need for a system and method for exchanging of at least one item, the at least one item belonging to a plurality of comparable items devoid of the above limitations

### SUMMARY OF THE INVENTION

According to one aspect of the present invention there is provided a system for exchange of at least one item belonging to a plurality of comparable items. The system comprises (i) a mechanism for receiving the at least one item to be exchanged,(ii) a device for identifying and counting the at least one item to be exchanged and (iii) a distribution mechanism containing at least a portion of the plurality of comparable items. The distribution mechanism is designed and configured to dispense one of the plurality of comparable items for each of the at least one item to be exchanged received by the mechanism for receiving.

According to another aspect of the present invention there is provided a system for exchange of at least one item, the at least one item to be exchanged belonging to a plurality of comparable items. The system comprises (a) a mechanism for receiving the at least one item to be exchanged; (b) a device for identifying and counting the at least one item to be exchanged; and (c) a distribution mechanism containing at least a portion of the plurality of the comparable items. The distribution mechanism is designed and configured to dispense a comparable item for each of the at least one item to be exchanged received by the mechanism for receiving items, wherein receipt, identification and counting of the at least one item to be exchanged and dispensing of the exchange items occur rapidly and consecutively.

According to yet another aspect of the present invention there is provided a method for exchange of at least one item, the at least one item to be exchanged belonging to a plurality of comparable items. The method includes the steps of (a) receiving the at least one item to be exchanged; (b) identifying and counting the at least one item to be exchanged; and (c) distributing at least a portion of the plurality of the comparable items by dispensing a comparable item for each of the at least one item to be exchanged received wherein the receiving, identifying and counting of the at least one item to be exchanged and dispensing of the comparable items occur rapidly and consecutively.

According to further features in preferred embodiments of the invention described below, the process of receiving, identifying, counting the at least one item to be exchanged and dispensing said comparable exchange item occurs rapidly and consecutively.

According to still further features in the described preferred embodiments the mechanism for receiving is a receptacle which, upon detection of the at least one item to be exchanged prevents retrieval of the at least one item to be exchanged placed therein.

According to still further features in the described preferred embodiments the device for identifying and counting the at least one item to be exchanged relies upon at least one mechanism selected from the group consisting of bar-code reading, radio frequency transmission and electromagnetic detection.

According to still further features in the described preferred embodiments the device for identifying and counting the at least one item to be exchanged further comprises a display showing at least one property selected from the group consisting of number and category of the at least one item to be exchanged placed in the receiving mechanism.

According to still further features in the described preferred embodiments the distribution mechanism further comprises a panel showing credits for each of the at least one item to be exchanged, the credits decreasing as the comparable items are removed from the distribution mechanism.

According to still further features in the described preferred embodiments the distribution mechanism further comprises separate cells that dispense the replacement items.

According to still further features in the described preferred embodiments the distribution mechanism further comprises a token dispenser.

According to still further features in the described preferred embodiments the token dispenser dispenses an item selected from the group consisting of a coupon, a token, a ticket, a slip, a coin, a card with magnetic stripe and a smart card.

According to still further features in the described preferred embodiments the at least one item to be exchanged and the comparable items are fabric items.

According to still further features in the described preferred embodiments the method includes the additional steps of: (d) detecting the at least one item to be exchanged after it is received in a receptacle; and (e) preventing retrieval of the at least one item to be exchanged from the receptacle once placed therein.

According to still further features in the described preferred embodiments the steps of identifying and counting rely upon at least one mechanism selected from the group consisting of bar-code reading, radio frequency transmission and electromagnetic detection.

According to still further features in the described preferred embodiments the method includes the additional step of displaying at least one property selected from the group consisting of number and category of items received.

According to still further features in the described preferred embodiments the method includes the additional step of showing credits for the at least one item to be exchanged the credits decreasing in number as comparable items are distributed.

According to still further features in the described preferred embodiments the method includes the additional step of choosing comparable items, wherein chosen comparable items are dispensed from separate cells.

According to still further features in the described preferred embodiments the method is applied to fabric items.

The present invention successfully addresses the shortcomings of the presently known configurations by providing a system where the receiving, identifying, counting and the return of comparable items occur in a rapid and consecutive process.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a perspective view of a system for exchange of at least one item belonging to a plurality of comparable items according to the present invention;

FIG. 2 is a semi-transparent perspective view of a receiving mechanism according to the present invention;

FIG. 3 is a front view of a display and panel showing credits according to the present invention;

FIG. 4 is a perspective view of a distribution mechanism containing at least a portion of a plurality of comparable items; and

FIG. 5 is a flow diagram of a method for exchange of at least one item, the at least one item to be exchanged belonging to a plurality of comparable items.

### DESCRIPTION OF THE PREFERRED EMBODIMENTS

The present invention is of a system and method for exchanging of at least one item belonging to a plurality of comparable items. More specifically the invention relates to a system and method for exchanging fabric items such as institutional laundry, wherein the fabric items are received, identified, counted and immediately replaced.

The principles and operation of a system and method for exchanging of at least one item belonging to a plurality of comparable items according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

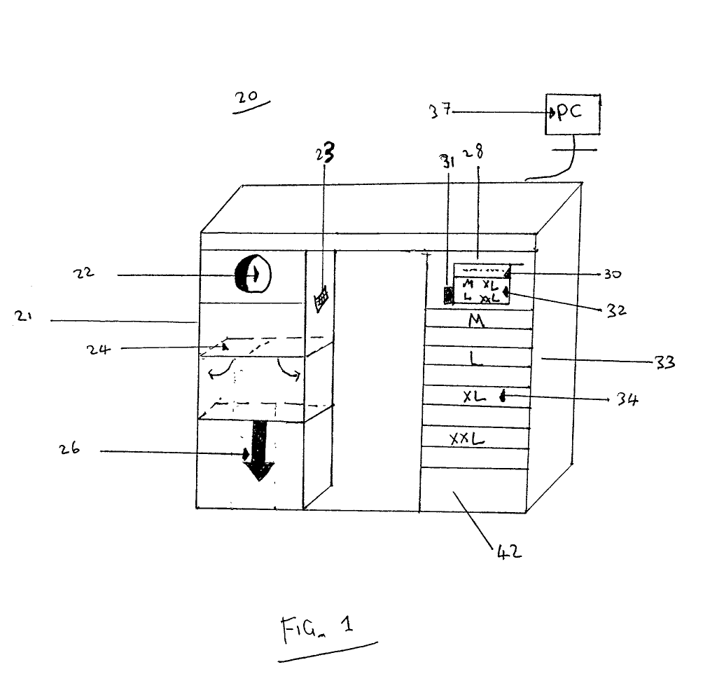

Referring now to the drawings, FIG. 1 illustrates a system 20 for exchange of at least one item belonging to a plurality of comparable items. The system includes a mechanism 21 for receiving the at least one item to be exchanged. System 20, further includes a device 23 for identifying and counting the at least one item to be exchanged and a distribution mechanism 33 containing at least a portion of the plurality of comparable items 36. Distribution mechanism 33 is designed and configured to dispense one of the plurality of comparable items 36 for each of the at least one item to be exchanged, received by mechanism for receiving 21.

According to preferred embodiments of system 20, the process of receiving, identifying and counting the at least one item to be exchanged and dispensing the comparable exchange item occurs rapidly and consecutively.

In some cases, mechanism for receiving 21 is a receptacle (FIG. 2) which, upon detection of the at least one item to be exchanged prevents retrieval of the at least one item to be exchanged placed therein. This prevention may be achieved for example, by use of a trap door 24, which opens to allow the item being exchanged to fall through and subsequently closes. Alternatively, prevention of retrieval may be accomplished by having items being exchanged fall down a chute.

Device 23 for identifying and counting the at least one item to be exchanged may employ a variety of mechanisms, including but not limited to bar-code reading, radio frequency transmission and electromagnetic detection.

An example of a radio frequency transmission device suitable for use in the present invention is the Tag-It™ TIRIS™ (Texas Instruments™, U.S.A.). TIRIS™ employs sequential transmission of FM signals and electronic data capture. Primary to each TIRIS™ system are transponders, each of which is especially programmable with a unique code.

TIRIS™ employs radio transmissions to send energy to a transponder which returns a radio transmissions back to a data collection reader. The TIRIS™ transponder (tag) is attachable to or embeddable in objects, such as documents. A TIRIS™ reader-unit sends a radio frequency wave to the tag, and the tag broadcasts its stored data back to the reader. Data collected from a transponder can either be sent directly to a computer, or it can be stored in a reader and later sent to a computer for data processing via a wireless link connecting objects with information management systems.

Other commercially available components are equally suited for use in the present invention. One ordinarily skilled in the art will be capable of assembling and integrating such commercially available components for use in conjunction with the present invention.

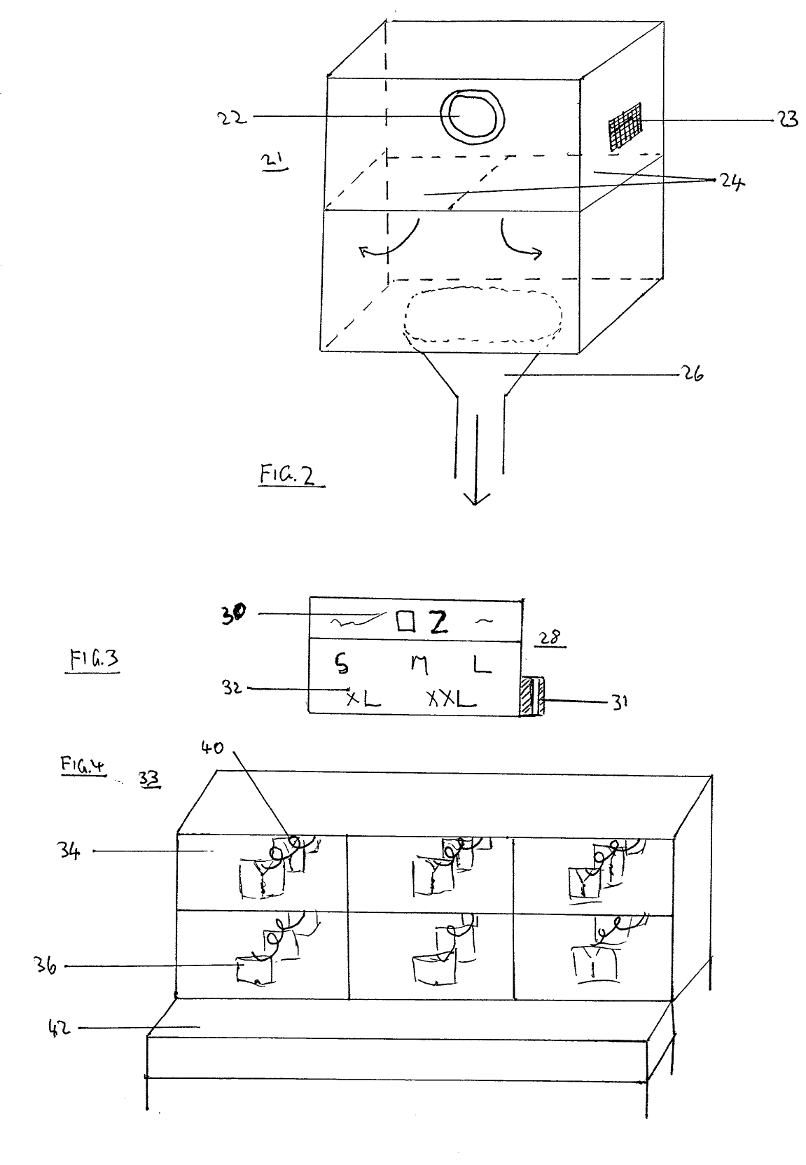

The device for identifying and counting the at least one item to be exchanged further may further include a display 30 (FIG. 3) showing at least one property of the at least one item to be exchanged placed in receiving mechanism. Properties might include, but are not limited to number and category.

Distribution mechanism 33 may further include a panel 28 showing credits for each of the at least one item to be exchanged, the credits decreasing as the comparable items are removed from the distribution mechanism 33 (FIG. 4).

Distribution mechanism 33 (FIG. 4) may in some cases, be constructed of separate cells 34 that dispense the replacement items.

Distribution mechanism 33 may further include a token dispenser 31 dispenses an item such as, for example, a coupon, a token, a ticket, a slip, a coin, a card with magnetic stripe and a smart card.

For purposes of this specification and the accompanying claims, a “smart card” is defined as any tangible item which includes a read many write many memory device capable of performing debit/credit operations. This definition includes, but is not limited to items which contain microchips.

Token dispensers are commercially available. As an example of a higher technology than tokens, Schlumberger produces a smart card system which identifies the worker, stores his credits on the memory chip in the card which allows for a later removal of comparative items and prevents the worker from receiving more than he is credited for. This system allows for personal use statistics in addition to keeping a computerized stock list.

According to some embodiments of the invention, the at least one item to be exchanged and the comparable items are fabric items. Rapid automated exchange of fabric items is often desirable in institutional settings such as factories, hospitals, dormitories, military barracks, gymnasia, swimming pools and educational institutions. Typically, but not always, the exchange will be of a used or soiled item for a comparable clean item.

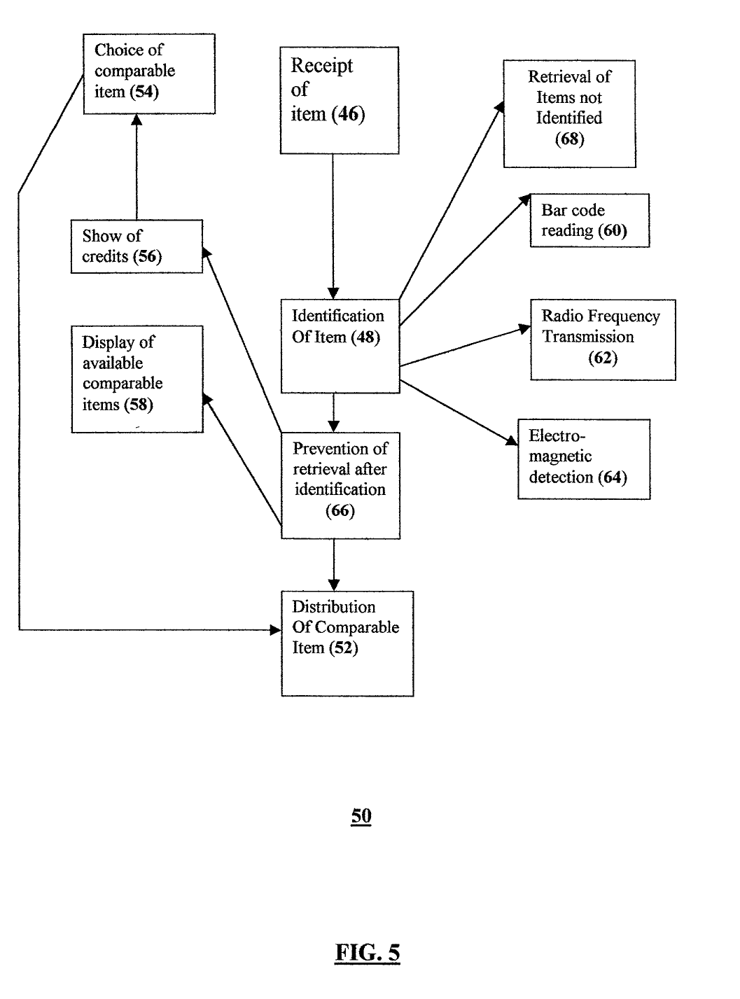

The present invention is further embodied by a method 50 (FIG. 5) for exchange of at least one item, the at least one item to be exchanged belonging to a plurality of comparable items. Method 50 includes the steps of receiving the at least one item to be exchanged 46 and identifying and counting the at least one item to be exchanged 48; and (c) distributing at least a portion of the plurality of the comparable 52 items by dispensing a comparable item for each of the at least one item to be exchanged received. Receiving 46, identifying and counting 48 of the at least one item to be exchanged and dispensing of the comparable items 52 occur rapidly and consecutively according to preferred embodiments of method 50.

Method 50 may further include the additional steps of detecting 48 the at least one item to be exchanged after it is received in a receptacle 21, and 66 preventing retrieval of the at least one item to be exchanged from the receptacle once placed therein.

The steps of identifying and counting 48 may rely upon any one of a number of mechanisms as detailed hereinabove.

Method 50 may further include displaying of at least one property of the item to be exchanged, including but not limited to, number and category of items received 56. Such display will be affected by display 56 as described hereinabove.

Method 50 may further include the step of showing 56 credits for the at least one item to be exchanged the credits decreasing in number as comparable items are distributed 56. Display 56 may be for example an LCD display, an LED display or a CRT display. Alternately or additionally display 56 may include audio presentation of information, for example via at least one loudspeaker.

Method 50 may further include choosing 54 comparable items 58, from separate cells.

As a non-limiting illustrative example of the above system and method, let us consider a hospital worker leaving the hospital at the end of a shift. The worker will deposit his soiled work-clothes into the receptacle 22 of the mechanism of receiving 21. The article of clothing is identified by a detector 23 which detects an embedded device on the article of clothing, for example by bar-code reading 60, radio frequency transmission 62, electro magnetic transmission 64 or any other technically feasible means.

Upon detection the article of clothing falls through the trap doors 24 and then through a chute 26 to the hospital's central laundry. This effectively prevents retrieval by the worker while simultaneously crediting the wearer with one piece of clothing (for example a pair of pants) which shows immediately on the display 30 as well, in some cases, emitting a beep or other audible signal. If for some reason the article of clothing is not detected in the identification stage 48, the worker has an opportunity to retrieve the item 68. In some cases, the worker can then either choose 54 a comparable article of clothing from a panel 32. In other cases a comparable item of clothing 36 is automatically dispensed from distribution mechanism 33. The comparable article of clothing 36, pushed forward by a spiral 40 which allows for only one article of clothing to be dispensed at a time into a receiving trough 42. The worker then takes his clean clothes home, leaves them in his locker for wearing on the next workday. Alternatively, the worker may receive a token from the token dispenser 31 for use at a later time for example upon return to work the following day. According to other preferred embodiments of the system 20 and method 50 of the present invention, a computer system 37 keeps track of movement and management of inventories and stock. System 21 and method 50 prevent workers from taking more than the quantity of articles of clothing given into the system and method and also save the institution the cost of employing a dedicated worker to replace the clothing.

As described hereinabove, the system and method of the present invention could also be advantageously employed in the context of a hotel swimming pool where they would serve to facilitate the exchange of used towels for new ones. The system and method of the present invention could also be employed for the exchange of non-fabric items such as books or VCR cassettes.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for exchange of at least one item, the least one item belonging to a plurality of comparable items, the system comprising:
(a) a mechanism for receiving the at least one item to be exchanged;
(b) a device for identifying and counting the at least one item to be exchanged;
© a distribution mechanism containing at least a portion of the plurality of comparable items, said distribution mechanism designed and configured to dispense one of the plurality of comparable items for each of the at least one item to be exchanged, received by said mechanism for receiving.

2. The system of claim 1, wherein the process of receiving, identifying, counting the at least one item to be exchanged and dispensing said comparable exchange item occurs rapidly and consecutively.

3. The system of claim 1, wherein said mechanism for receiving is a receptacle which, upon detection of said at least one item to be exchanged prevents retrieval of said at least one item to be exchanged placed therein.

4. The system of claim 1, wherein the device for identifying and counting the at least one item to be exchanged relies upon at least one mechanism selected from the group consisting of bar-code reading, radio frequency transmission and electromagnetic detection.

5. The system of claim 4, wherein said device for identifying and counting the at least one item to be exchanged further comprises a display showing at least one property selected from the group consisting of number and category of the at least one item to be exchanged placed in said receiving mechanism.

6. The system of claim 1, wherein said distribution mechanism further comprises a panel showing credits for each of the at least one item to be exchanged, said credits decreasing as the comparable items are removed from said distribution mechanism.

7. The system of claim 6, wherein said distribution mechanism further comprises separate cells that dispense the replacement items.

8. The system of claim 6, wherein said distribution mechanism further comprises a token dispenser.

9. The system of claim 8, wherein said token dispenser dispenses an item selected from the group consisting of a coupon, a token, a ticket, a slip, a coin, a card with magnetic stripe and a smart card.

10. The system of claim 1, wherein the at least one item to be exchanged and the comparable items are fabric items.

11. A system for exchange of at least one item, the at least one item to be exchanged belonging to a plurality of comparable items, the system comprising:
(a) a mechanism for receiving the at least one item to be exchanged;
(b) a device for identifying and counting the at least one item to be exchanged;
© a distribution mechanism containing at least a portion of the plurality of the comparable items, said distribution mechanism designed and configured to dispense a comparable items for each of the at least one item to be exchanged received by said mechanism for receiving items, wherein receipt, identification and counting of said at least one item to be exchanged and dispensing of the exchange items occur rapidly and consecutively.

12. The system of claim 11, wherein said mechanism for receiving is a receptacle which, upon detection of said at least one item to be exchanged prevents retrieval of said at least one item to be exchanged placed therein.

13. The system of claim 11, wherein said device for identifying and counting said at least one item to be exchanged relies upon at least one mechanism selected from the group consisting of bar-code reading, radio frequency transmission and electromagnetic detection.

14. The system of claim 13, wherein said device for identifying and counting the at least one item to be exchanged further comprises a display showing at least one property selected from the group consisting of number and category of the at least one item to be exchanged placed in said receiving mechanism.

15. The system of claim 11, wherein said distribution mechanism further comprises a panel showing credits for each of the at least one item to be exchanged, said credits decreasing as the comparable items are removed from said distribution mechanism.

16. The system of claim 15, wherein said distribution mechanism further comprises separate cells that dispense the comparable items.

17. The system of claim 11, wherein said at least one item to be exchanged and the comparative items are fabric items.

18. A method for exchange of at least one item, the at least one item to be exchanged belonging to a plurality of comparable items, said method including the steps of:
(a) receiving the at least one item to be exchanged;
(b) identifying and counting the at least one item to be exchanged;
© distributing at least a portion of the plurality of the comparable items by dispensing a comparable item for each of the at least one item to be exchanged received wherein said receiving, identifying and counting of the at least one item to be exchanged and dispensing of the comparable items occur rapidly and consecutively.

19. The method of claim 16, comprising the additional steps of:
(d) detecting said at least one item to be exchanged after it is received in a receptacle;
(e) preventing retrieval of the at least one item to be exchanged from said receptacle once placed therein.

18. The method of claim 16, wherein said steps of identifying and counting rely upon at least one mechanism selected from the group consisting of bar-code reading, radio frequency transmission and electromagnetic detection.

19. The method of claim 18, comprising the additional step of displaying at least one property selected from the group consisting of number and category of items received.

20. The method of claim 16, comprising the additional step of showing credits for the at least one item to be exchanged said credits decreasing in number as comparable items are distributed.

21. The method of claim 20, comprising the additional step of choosing comparable items, wherein chosen comparable items are dispensed from separate cells.

22. The method of claim 16, wherein the items are fabric items.
